(19) United States
(12) Patent Application Publication
(10) Pub. No.: US 2019/0172060 A1
(43) Pub. Date: Jun. 6, 2019

(54) "Method And System For Secure Transactions Between User Transaction Accounts"

(71) Applicant: Visa International Service Association, San Francisco, CA (US)

(72) Inventor: Howard Marc Wettan, Burlingame, CA (US)

(21) Appl. No.: 15/830,315

(22) Filed: Dec. 4, 2017

(51) Int. Cl. G06Q 20/38

(52) U.S. Cl. CPC G06Q 20/3821; G06Q 20/38215

(57) ABSTRACT

Described are a system and method for securely completing a transaction between a first transaction account of a first user and a second transaction account of a second user. A described method includes generating a first account pay-send token and a second account pay-receive token and assigning the first account pay-send token to the first transaction account and the second account pay-receive token to the second transaction account. The method also includes receiving a transaction request from a first account management device and determining account identifications for the first transaction account and the second transaction account. The method further includes transmitting transaction instructions to an issuer institution, the transaction instructions configured to facilitate completion of the transaction from the first transaction account to the second transaction account for the transaction value.

### BACKGROUND OF THE INVENTION

### 1. Field of the Invention

Disclosed embodiments relate generally to a system and method for securely completing a transaction between a first transaction account of a first user and a second transaction account of a second user, and in preferred and non-limiting embodiments or aspects, to a system and method for generating, assigning, and using pay-directional tokens to securely complete person-to-person transactions.

### 2. Technical Considerations

Security, efficiency, and flexibility are important priorities for person-to-person transaction systems, and many such systems and applications have sprung up to address a perceived need in the industry. Person-to-person transaction systems are often platform-exclusive and proprietary, requiring system users to register and interact only with other system users. In a common use case, individuals with electronic devices containing digital wallets may desire to pay one another directly, in person-to-person transactions. Known implementations typically rely on an enrollment process by which a user provides an alias (e.g., username, phone number, email address, etc.), enrolls a payment card, and makes or receives a payment via the payment card in the system. These systems typically require registration and log-in before transactions can be completed, and such systems often restrict transactions to other like system users. Moreover, these systems are generally centrally controlled, without flexible direct interaction between the users. On the other hand, systems that employ decentralized, user-centric applications tend to sacrifice security because of the volume of transmitted user-identifying credentials and account identifiers.

There is a need in the art for a secure, efficient, and flexible person-to-person transaction system and method, in which users may interact directly to complete a transaction, and in which the users need not enroll in a number of different card-management applications to transact with various other users. Furthermore, there is a need in the art for such a system and method to be secure, to reduce the risk of sensitive information being intercepted by third parties.

### SUMMARY OF THE INVENTION

Accordingly, and generally, provided is an improved system and computer-implemented method for securely completing a transaction between a first transaction account of a first user and a second transaction account of a second user. Preferably, provided is a system and computer-implemented method for generating a pay-send token for the first transaction account, associated with a first financial device, and generating a pay-receive token for the second transaction account, associated with a second financial device. Preferably, provided is a system and computer-implemented method for receiving a transaction request, including the pay-send token and pay-receive token, and determining account identifications based at least partially on the tokens. Preferably, provided is a system and computer-implemented method for transmitting transaction instructions to complete the transaction, in response to determining the account identifications.

According to one preferred and non-limiting embodiment or aspect, provided is a computer-implemented method for securely completing a transaction between a first transaction account of a first user and a second transaction account of a second user. The method includes generating, with at least one processor, a first account pay-send token and a second account pay-receive token. The method also includes assigning, with at least one processor, the first account pay-send token to the first transaction account in a token database. The first transaction account is associated with at least one first financial device. The method further includes assigning, with at least one processor, the second account pay-receive token to the second transaction account in the token database. The second transaction account is associated with at least one second financial device. The method further includes receiving, with at least one processor, a transaction request from a first account management device of the first user. The transaction request includes at least the first account pay-send token, the second account pay-receive token, and a transaction value. The method further includes determining, with at least one processor and based at least partially on the first account pay-send token and the second account pay-receive token, account identifications for the first transaction account and the second transaction account. The method further includes transmitting, with at least one processor and in response to determining the account identifications, transaction instructions to at least an issuer institution of the at least one first financial device. The transaction instructions are configured to facilitate completion of the transaction from the first transaction account to the second transaction account for the transaction value.

In further preferred and non-limiting embodiments or aspects, the method may include communicating, with at least one processor, a confirmation to the first account management device of the first user and a confirmation to a second account management device of the second user when the transaction is completed. The method may also include communicating, from the first account management device to the second account management device and with at least one processor, an offer to pay the transaction value. The method may further include communicating, from the second account management device to the first account management device and with at least one processor, an acceptance of the offer. The acceptance may include the second account pay-receive token.

In further preferred and non-limiting embodiments or aspects, the first account management device may retain the second account pay-receive token and transmit transaction requests without further communicating offers to pay transaction values and without further receiving acceptances of offers to pay transaction values. The method may include generating, with at least one processor, a pay-receive verification cryptogram to authenticate the second account pay-receive token. The pay-receive verification cryptogram may be configured to be transmitted with the second account pay-receive token from the second account management device to the first account management device in the acceptance of the offer by the second user. The method may also include generating, with at least one processor, a pay-send verification cryptogram to authenticate the first account pay-send token and define a domain of permitted payments using the first account pay-send token. The pay-send verification cryptogram may be configured to be transmitted with the first account pay-send token, the second account pay-receive token, and the pay-receive verification cryptogram from the first account management device in the transaction request.

In further preferred and non-limiting embodiments or aspects, the method may include generating, with at least one processor, a first account pay-receive token and a second account pay-send token. The method may also include assigning, with at least one processor, the first account pay-receive token to the first transaction account in the token database and the second account pay-send token to the second transaction account in the token database. The method may further include transmitting, with at least one processor, the first account pay-send token and the first account pay-receive token to the first account management device of the first user in response to registration of the at least one first financial device with a digital wallet. The method may further include transmitting, with at least one processor, the second account pay-send token and the second account pay-receive token to a second account management device of the second user in response to registration of the at least one second financial device with a digital wallet. The transaction may also include a recurring transaction, and the method may further include communicating, with at least one processor and based at least partially on the transaction request, with at least the issuer institution of the at least one first financial device to complete the recurring transaction at predetermined intervals.

According to one preferred and non-limiting embodiment or aspect, provided is a system for securely completing a transaction between a first transaction account of a first user and a second transaction account of a second user. The system includes a first non-transitory computer readable medium containing program instructions executable by a first account management device including at least one processor. The program instructions are programmed or configured to facilitate management of at least one first financial device associated with the first transaction account. The first transaction account is assigned at least a first account pay-send token. The system also includes a second non-transitory computer readable medium containing program instructions executable by a second account management device including at least one processor. The program instructions are programmed or configured to facilitate management of at least one second financial device associated with the second transaction account. The second transaction account is assigned at least a second account pay-receive token. The system further includes at least one token management server in communication with a token database and programmed or configured to generate the first account pay-send token and the second account pay-receive token. The token management server is also programmed or configured to assign the first account pay-send token to the first transaction account in the token database and to assign the second account pay-receive token to the second transaction account in the token database. The token management server is further programmed or configured to, in response to receiving a transaction request from the first account management device, query financial devices corresponding to each token and communicate with at least an issuer institution of the at least one first financial device to complete the transaction from the first transaction account to the second transaction account for a transaction value.

In further preferred and non-limiting embodiments or aspects, the transaction request may include at least the first account pay-send token, the second account pay-receive token, and the transaction value. The at least one token management server may be further programmed or configured to communicate a confirmation to the first user device and the second user device when the transaction is completed. The at least one token management server may also be programmed or configured to generate a pay-receive verification cryptogram to authenticate the second account pay-receive token, the pay-receive verification cryptogram configured to be transmitted with the second account pay-receive token from the second account management device to the first account management device for acceptance of the transaction by the second user. The at least one token management server may be further programmed or configured to generate a pay-send verification cryptogram to authenticate the first account pay-send token and define a domain of permitted payments using the first account pay-send token, the pay-send verification cryptogram configured to be transmitted with the first account pay-send token, the second account pay-receive token, and the pay-receive verification cryptogram from the first account management device in the transaction request.

In further preferred and non-limiting embodiments or aspects, the at least one token management server may be programmed or configured to generate a first account pay-receive token and a second account pay-send token. The at least one token management server may also be programmed or configured to assign the first account pay-receive token to the first transaction account in the token database and the second account pay-send token to the second transaction account in the token database. The at least one token management server may be further programmed or configured to transmit the first account pay-send token and the first account pay-receive token to the first account management device in response to registration of the at least one first financial device with a digital wallet. The at least one token management server may be further programmed or configured to transmit the second account pay-send token and the second account pay-receive token to the second account management device in response to registration of the at least one second financial device with a digital wallet. The transaction may also include a recurring transaction and the transaction request may be further configured to cause the at least one token management server to communicate with at least the issuer institution of the at least one first financial device to complete the recurring transaction at predetermined intervals.

According to one preferred and non-limiting embodiment or aspect, provided is a computer-implemented method for securely completing a transaction between a first transaction account of a first user and a second transaction account of a second user. The method includes receiving, with at least one processor, input by the first user including financial device data for a first financial device associated with the first transaction account, the financial device data including at least one of the following: a first financial device identifier, a first financial device billing address, a first financial device security code, a first financial device expiration date, or any combination thereof. The method also includes transmitting, with at least one processor, a request to a token management server to generate new transaction account tokens, the new transaction account tokens including a first account pay-send token and a first account pay-receive token associated with the first transaction account. The method further includes receiving from the token management server, with at least one processor, the new transaction account tokens. The method further includes generating and transmitting to an account management device of the second user, with at least one processor, an invitation to transact for a transaction value. The method further includes receiving from the account management device of the second user, with at least one processor, a communication accepting the invitation to transact.

In further preferred and non-limiting embodiments or aspects, the invitation to transact may be for payment from the first user to the second user. The communication accepting the invitation may include a second account pay-receive token associated with the second transaction account. The method may include transmitting, with at least one processor, a transaction request to the token management server including the first account pay-send token, the second account pay-receive token, and the transaction value. The transaction request may be configured to cause the token management server to query financial devices corresponding to each transmitted token and communicate with at least an issuer institution of the first financial device to complete the transaction from the first transaction account to the second transaction account for the transaction value. The transaction may include a recurring transaction and the transaction request may be further configured to cause the token management server to communicate with at least the issuer institution of the first financial device to complete the recurring transaction at predetermined intervals. The transaction may also include a repeated transaction, the method further including storing the second account pay-receive token for transmission in the transaction request, the transaction request to be initiated by the first user at a plurality of different times. The communication accepting the invitation to transact may further include a pay-receive verification cryptogram to authenticate the second account pay-receive token. The transaction request may further include a pay-send verification cryptogram to authenticate the first account pay-send token and define a domain of permitted payments using the first account pay-send token.

In further preferred and non-limiting embodiments or aspects, the invitation to transact may be for payment from the second user to the first user and may include the first account pay-receive token. The communication accepting the invitation may represent confirmation of a submission of a transaction request to the token management server by the account management device of the second user. The first account pay-receive token may be configured to be paired with a second account pay-send token associated with the second transaction account and to be transmitted in the transaction request to the token management server.

Other preferred and non-limiting embodiments or aspects of the present invention will be set forth in the following numbered clauses:

Clause 1: A computer-implemented method for securely completing a transaction between a first transaction account of a first user and a second transaction account of a second user, the method comprising: generating, with at least one processor, a first account pay-send token and a second account pay-receive token; assigning, with at least one processor, the first account pay-send token to the first transaction account in a token database, the first transaction account associated with at least one first financial device; assigning, with at least one processor, the second account pay-receive token to the second transaction account in the token database, the second transaction account associated with at least one second financial device; receiving, with at least one processor, a transaction request from a first account management device of the first user, the transaction request comprising at least the first account pay-send token, the second account pay-receive token, and a transaction value; determining, with at least one processor and based at least partially on the first account pay-send token and the second account pay-receive token, account identifications for the first transaction account and the second transaction account; and transmitting, with at least one processor and in response to determining the account identifications, transaction instructions to at least an issuer institution of the at least one first financial device, the transaction instructions configured to facilitate completion of the transaction from the first transaction account to the second transaction account for the transaction value.

Clause 2: The method of clause 1, further comprising communicating, with at least one processor, a confirmation to the first account management device of the first user and a confirmation to a second account management device of the second user when the transaction is completed.

Clause 3: The method of clause 1 or 2, further comprising communicating, from the first account management device to the second account management device and with at least one processor, an offer to pay the transaction value.

Clause 4: The method of any of clauses 1-3, further comprising communicating, from the second account management device to the first account management device and with at least one processor, an acceptance of the offer, the acceptance comprising the second account pay-receive token.

Clause 5: The method of any of clauses 1-4, wherein the first account management device retains the second account pay-receive token and transmits transaction requests at predetermined intervals without further communicating offers to pay transaction values and without further receiving acceptances of offers to pay transaction values.

Clause 6: The method of any of clauses 1-5, further comprising generating, with at least one processor, a pay-receive verification cryptogram to authenticate the second account pay-receive token, the pay-receive verification cryptogram configured to be transmitted with the second account pay-receive token from the second account management device to the first account management device in the acceptance of the offer by the second user.

Clause 7: The method of any of clauses 1-6, further comprising generating, with at least one processor, a pay-send verification cryptogram to authenticate the first account pay-send token and define a domain of permitted payments using the first account pay-send token, the pay-send verification cryptogram configured to be transmitted with the first account pay-send token, the second account pay-receive token, and the pay-receive verification cryptogram from the first account management device in the transaction request.

Clause 8: The method of any of clauses 1-7, further comprising: generating, with at least one processor, a first account pay-receive token and a second account pay-send token; assigning, with at least one processor, the first account pay-receive token to the first transaction account in the token database and the second account pay-send token to the second transaction account in the token database; transmitting, with at least one processor, the first account pay-send token and the first account pay-receive token to the first account management device of the first user in response to registration of the at least one first financial device with a digital wallet; and transmitting, with at least one processor, the second account pay-send token and the second account pay-receive token to a second account management device of the second user in response to registration of the at least one second financial device with a digital wallet.

Clause 9: The method of any of clauses 1-8, wherein the transaction comprises a recurring transaction, the method further comprising communicating, with at least one processor and based at least partially on the transaction request, with at least the issuer institution of the at least one first financial device to complete the recurring transaction at predetermined intervals.

Clause 10: A system for securely completing a transaction between a first transaction account of a first user and a second transaction account of a second user, the system comprising: a first non-transitory computer readable medium containing program instructions executable by a first account management device comprising at least one processor, the program instructions programmed or configured to facilitate management of at least one first financial device associated with the first transaction account, the first transaction account being assigned at least a first account pay-send token; a second non-transitory computer readable medium containing program instructions executable by a second account management device comprising at least one processor, the program instructions programmed or configured to facilitate management of at least one second financial device associated with the second transaction account, the second transaction account being assigned at least a second account pay-receive token; and at least one token management server in communication with a token database and programmed or configured to: generate the first account pay-send token and the second account pay-receive token; assign the first account pay-send token to the first transaction account in the token database; assign the second account pay-receive token to the second transaction account in the token database; and in response to receiving a transaction request from the first account management device, query financial devices corresponding to each token and communicate with at least an issuer institution of the at least one first financial device to complete the transaction from the first transaction account to the second transaction account for a transaction value.

Clause 11: The system of clause 10, wherein the transaction request comprises at least the first account pay-send token, the second account pay-receive token, and the transaction value.

Clause 12: The system of clause 10 or 11, wherein the at least one token management server is further programmed or configured to communicate a confirmation to the first user device and the second user device when the transaction is completed.

Clause 13: The system of any of clauses 10-12, wherein the at least one token management server is further programmed or configured to generate a pay-receive verification cryptogram to authenticate the second account pay-receive token, the pay-receive verification cryptogram configured to be transmitted with the second account pay-receive token from the second account management device to the first account management device for acceptance of the transaction by the second user.

Clause 14: The system of any of clauses 10-13, wherein the at least one token management server is further programmed or configured to generate a pay-send verification cryptogram to authenticate the first account pay-send token and define a domain of permitted payments using the first account pay-send token, the pay-send verification cryptogram configured to be transmitted with the first account pay-send token, the second account pay-receive token, and the pay-receive verification cryptogram from the first account management device in the transaction request.

Clause 15: The system of any of clauses 10-14, wherein the at least one token management server is further programmed or configured to: generate a first account pay-receive token and a second account pay-send token; assign the first account pay-receive token to the first transaction account in the token database and the second account pay-send token to the second transaction account in the token database; transmit the first account pay-send token and the first account pay-receive token to the first account management device in response to registration of the at least one first financial device with a digital wallet; and transmit the second account pay-send token and the second account pay-receive token to the second account management device in response to registration of the at least one second financial device with a digital wallet.

Clause 16: The system of any of clauses 10-15, wherein the transaction comprises a recurring transaction and the transaction request is further configured to cause the at least one token management server to communicate with at least the issuer institution of the at least one first financial device to complete the recurring transaction at predetermined intervals.

Clause 17: A computer-implemented method for securely completing a transaction between a first transaction account of a first user and a second transaction account of a second user, the method comprising: receiving, with at least one processor, input by the first user comprising financial device data for a first financial device associated with the first transaction account, the financial device data comprising at least one of the following: a first financial device identifier, a first financial device billing address, a first financial device security code, a first financial device expiration date, or any combination thereof; transmitting, with at least one processor, a request to a token management server to generate new transaction account tokens, the new transaction account tokens comprising a first account pay-send token and a first account pay-receive token associated with the first transaction account; receiving from the token management server, with at least one processor, the new transaction account tokens; generating and transmitting to an account management device of the second user, with at least one processor, an invitation to transact for a transaction value; and receiving from the account management device of the second user, with at least one processor, a communication accepting the invitation to transact.

Clause 18: The method of clause 17, wherein the invitation to transact is for payment from the first user to the second user, and wherein the communication accepting the invitation comprises a second account pay-receive token associated with the second transaction account, the method further comprising transmitting, with at least one processor, a transaction request to the token management server comprising the first account pay-send token, the second account pay-receive token, and the transaction value, the transaction request configured to cause the token management server to query financial devices corresponding to each transmitted token and communicate with at least an issuer institution of the first financial device to complete the transaction from the first transaction account to the second transaction account for the transaction value.

Clause 19: The method of clause 17 or 18, wherein the transaction comprises a recurring transaction and the transaction request is further configured to cause the token management server to communicate with at least the issuer institution of the first financial device to complete the recurring transaction at predetermined intervals.

Clause 20: The method of any of clauses 17-19, wherein the transaction comprises a repeated transaction, the method further comprising storing the second account pay-receive token for transmission in the transaction request, the transaction request to be initiated by the first user at a plurality of different times.

Clause 21: The method of any of clauses 17-20, wherein the communication accepting the invitation to transact further comprises a pay-receive verification cryptogram to authenticate the second account pay-receive token.

Clause 22: The system of any of clauses 17-21, wherein the transaction request further comprises a pay-send verification cryptogram to authenticate the first account pay-send token and define a domain of permitted payments using the first account pay-send token.

Clause 23: The method of any of clauses 17-22, wherein the invitation to transact is for payment from the second user to the first user and comprises the first account pay-receive token, and wherein the communication accepting the invitation represents confirmation of a submission of a transaction request to the token management server by the account management device of the second user, the first account pay-receive token configured to be paired with a second account pay-send token associated with the second transaction account and to be transmitted in the transaction request to the token management server.

Clause 24: A computer-implemented method for securely completing a transaction between a first transaction account of a first user and a second transaction account of a second user, the method comprising: receiving, with at least one processor, input by the first user comprising financial device data for a first financial device associated with the first transaction account, the financial device data comprising at least one of the following: a first financial device identifier, a first financial device billing address, a first financial device security code, a first financial device expiration date, or any combination thereof; transmitting, with at least one processor, a request to a token management server to generate new transaction account tokens, the new transaction account tokens comprising a first account pay-send token and a first account pay-receive token associated with the first transaction account; receiving from the token management server, with at least one processor, the new transaction account tokens; receiving from an account management device of the second user, with at least one processor, an invitation to transact for a transaction value; and generating and transmitting to the account management device of the second user, with at least one processor, a communication accepting the invitation to transact.

Clause 25: The method of clause 24, wherein the invitation to transact is for payment from the second user to the first user, and wherein the communication accepting the invitation comprises the first account pay-receive token, the first account pay-receive token configured to be communicated, with a second account pay-send token associated with the second transaction account of the second user, in a transaction request to the token management server, the transaction request comprising the transaction value.

These and other features and characteristics of the present invention, as well as the methods of operation and functions of the related elements of structures and the combination of parts and economies of manufacture, will become more apparent upon consideration of the following description, Appendices, and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figure, in which:

FIG. 1 is a schematic diagram of one non-limiting embodiment or aspect of a system and method for securely completing a transaction between a first transaction account of a first user and a second transaction account of a second user;

FIG. 2 is a schematic diagram of one non-limiting embodiment or aspect of a system and method for securely completing a transaction between a first transaction account of a first user and a second transaction account of a second user;

FIG. 3 is a schematic diagram of one non-limiting embodiment or aspect of a system and method for securely completing a transaction between a first transaction account of a first user and a second transaction account of a second user;

FIG. 4 is a flow diagram of one non-limiting embodiment or aspect of a system and method for securely completing a transaction between a first transaction account of a first user and a second transaction account of a second user; and

FIG. 5 is a flow diagram of non-limiting one embodiment or aspect of a system and method for securely completing a transaction between a first transaction account of a first user and a second transaction account of a second user.

### DETAILED DESCRIPTION OF THE INVENTION

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations and step sequences, except where expressly specified to the contrary. It is also to be understood that the specific devices and process illustrated in the attached drawings, and described in the following specification, are simply exemplary embodiments of the invention. Hence, specific dimensions and other physical characteristics related to the embodiments disclosed herein are not to be considered as limiting. Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “transaction service provider” may refer to an entity that receives transaction authorization requests from merchants or other entities and provides guarantees of payment, in some cases through an agreement between the transaction service provider and an issuer institution. The terms “transaction service provider” and “transaction service provider system” may also refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “issuer institution” may refer to one or more entities, such as a bank, that provide accounts to customers for conducting payment transactions, such as initiating credit and/or debit payments. For example, an issuer institution may provide an account identifier, such as a personal account number (PAN), to a customer that uniquely identifies one or more accounts associated with that customer. The account identifier may be embodied on a physical financial instrument, such as a payment card, and/or may be electronic and used for electronic payments. The terms “issuer institution,” “issuer bank,” and “issuer system” may also refer to one or more computer systems operated by or on behalf of an issuer institution, such as a server computer executing one or more software applications. For example, an issuer system may include one or more authorization servers for authorizing a payment transaction.

As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases such that they can be used to conduct a transaction without directly using the original account identifier. In some examples, an original account identifier, such as a PAN, may be associated with a plurality of tokens for different individuals or purposes. An issuer institution may be associated with a bank identification number (BIN) or other unique identifier that uniquely identifies it among other issuer institutions.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices.

As used herein, the terms “electronic wallet,” “digital wallet,” and “electronic wallet application” refer to one or more electronic devices and/or software applications configured to initiate and/or conduct payment transactions. For example, an electronic wallet may include a mobile device executing an electronic wallet application, and may further include server-side software and/or databases for maintaining and providing transaction data to the mobile device. An “electronic wallet provider” may include an entity that provides and/or maintains an electronic wallet for a customer, such as Google Wallet™, Android Pay™, Samsung Pay®, and/or other like electronic payment systems. In some non-limiting examples, an issuer bank may be an electronic wallet provider.

As used herein, the term “financial device” may refer to a portable payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a mobile device executing an electronic wallet application, a personal digital assistant, a security card, an access card, a wireless terminal, and/or a transponder, as examples. The financial device may include a volatile or a non-volatile memory to store information, such as an account identifier or a name of the account holder. The financial device may store account credentials locally on the device, in digital or non-digital representation, or may facilitate accessing account credentials stored in a medium that is accessible by the financial device in a connected network.

As used herein, the term “server” may refer to or include one or more processors or computers, storage devices, or similar computer arrangements that are operated by or facilitate communication and processing for multiple parties in a network environment, such as the internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

The term “account data,” as used herein, refers to any data concerning one or more accounts for one or more users. Account data may include, for example, one or more account identifiers, user identifiers, transaction histories, balances, credit limits, issuer institution identifiers, and/or the like.

As used herein, the term “account management device” may refer to an apparatus or device having at least one processor that is configured to communicate with one or more networks and configured to store and/or retrieve account-identifying data for at least one transaction account. Account management devices may include, for example, mobile devices executing electronic wallet applications, computers accessing online portals, and/or the like. Account management devices may include a non-transitory computer readable medium containing program instructions that, when executed by at least one processor, cause the account management device to act in the system according to non-limiting embodiments or aspects of the present invention.

As used herein, the term “token management server” may refer to one or more servers configured to communicate with user account management devices in one or more networks, to generate, store, send, and/or receive transaction account tokens for the completion of transactions. Token management servers may be configured to generate one or more tokens and assign the tokens to one or more transaction accounts in a local memory, such as an associated database. Token management servers may or may not be associated with a transaction service provider, and may be further configured to communicate with issuer institutions to cause the completion of transactions between transaction accounts.

Non-limiting embodiments or aspects of the present invention are directed to a system and computer-implemented method for securely completing a transaction between a first transaction account of a first user and a second transaction account of a second user. Non-limiting embodiments or aspects of the present invention provide a computer system and network, including at least one server computer, to generate separate pay-send and pay-receive tokens to be associated with transaction accounts and employed by system users to complete transactions between themselves. Non-limiting embodiment or aspects of the present invention provide one technical advantage of allowing tokens to be designated as directional, having pay-send tokens and pay-receive tokens that authorize only sending or receiving into accounts, respectively. Non-limiting embodiments or aspects of the present invention provide the tools and systems for facilitating transaction invitations between system users, through the sending of identifying tokens, and through a token management server to receive transaction requests from transacting users and to communicate transaction instructions to corresponding issuer institutions. Non-limiting embodiments or aspects of the present invention provide the advantage of limiting the sensitive data being transmitted between users, while allowing users of disparate account management platforms to send transaction invitations without other users needing to sign up for the same account management platform. In particular, the types of tokens transmitted between users may be restricted to pay-receive tokens, which are less susceptible to nefarious uses, and token-specific cryptograms may be produced to define the scope of use of transmitted tokens. Recurring transactions can also be defined by user agreement and generated cryptograms, allowing multiple transactions to be completed without constant invitation and consent between users. Moreover, the platform-agnostic system of non-limiting embodiments or aspects of the present invention centrally manages account identification data and facilitates the completion of transactions through direction-specific transaction account tokens. To that end, one or more servers may securely and centrally manage token creation, token assignment, cryptograms, issuer transaction instructions, and transaction confirmation.

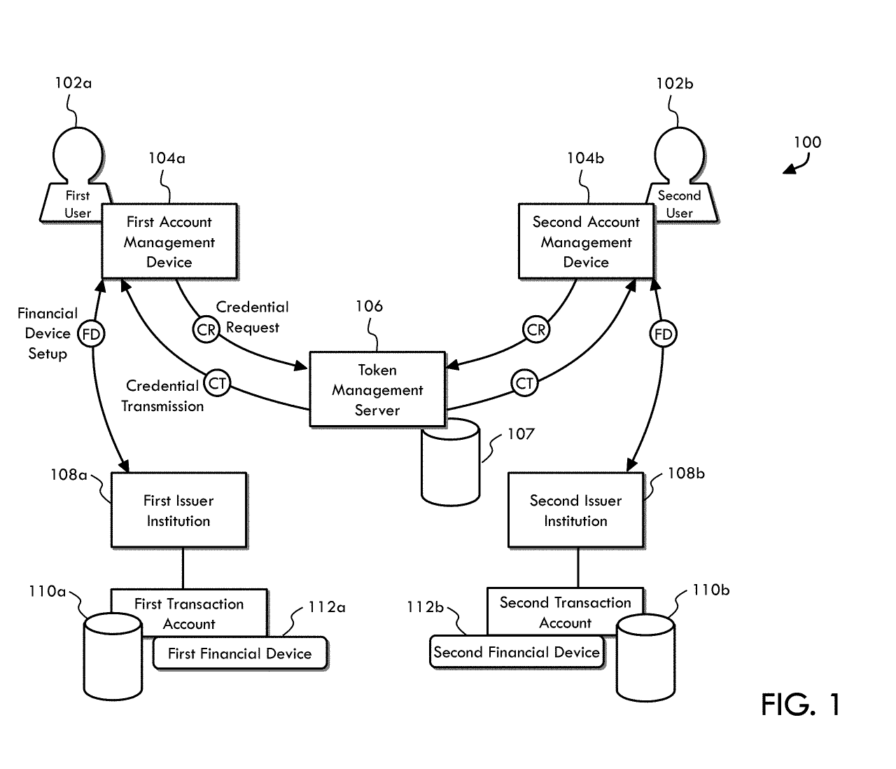

With specific reference to FIG. 1, and in preferred and non-limiting embodiments or aspects of the invention, provided is a system and method 100 for securely completing a transaction between a first transaction account of a first user and a second transaction account of a second user. Particularly, provided is a system and method 100 for generating and assigning tokens to transaction accounts. Depicted are a number of users 102a-102b, including a first user 102a and a second user 102b. It will be appreciated that the described interactions herein may be carried out for additional users. The first user 102a uses a first account management device 104a (e.g., mobile device, computer, server, etc.) to at least partly manage a first transaction account, such as to request, approve, review, and/or confirm transactions for the first transaction account, or other like action. The second user 102b uses a second account management device 104b (e.g., mobile device, computer, server, etc.) to at least partly manage a second transaction account, such as to request, approve, review, and/or confirm transactions for the second transaction account, or other like action. In one preferred and non-limiting example, a user 102a, 102b may have an account management device 104a, 104b that is a mobile device operating a digital wallet. Each user 102a, 102b may associate a financial device 112a, 112b with their respective account management device 104a, 104b. The financial device 112a, 112b is issued by a respective issuer institution 108a, 108b. The first issuer institution 108a may or may not be the same entity as the second issuer institution 108b. Each issuer institution 108a, 108b associates at least one financial device 112a, 112b with a transaction account for the respective user 102a, 102b and may store account data in an associated account database 110a, 110b. It will be appreciated that many configurations are possible.

With further reference to FIG. 1, and in further preferred and non-limiting embodiments or aspects of the invention, financial device setup (FD) is completed by associating a financial device 112a, 112b with an account management device 104a, 104b. A user 102a, 102b may input financial device data for their financial device 112a, 112b that includes at least one of the following: a first financial device identifier, a first financial device billing address, a first financial device security code, a first financial device expiration date, or any combination thereof. It is also possible to directly associate a transaction account with an account management device 104a, 104b, instead of, or in addition to, associating a financial device 112a, 112b. In one preferred and non-limiting example, a user 102a, 102b may register a financial device 112a, 112b, e.g., a credit card, with a digital wallet on their account management device 104a, 104b, e.g., a mobile device. After financial device setup (FD), the user 102a, 102b may send a credential request (CR) to a token management server 106. The credential request (CR) includes a communication configured to initiate generation and transmission of new transaction account tokens by the token management server 106. The credential request (CR) may further include transaction account data for the user's 102a, 102b associated transaction account and/or financial device 112a, 112b, such that a corresponding issuer institution 108a, 108b may be identified and transaction instructions may later be sent to an issuer institution 108a, 108b to complete a requested transaction. As such, the transaction account data of a credential request (CR) may include user name, user address, a user identifier, an account management device identifier, a financial device identifier, a transaction account identifier, an issuer institution identifier, or any combination thereof.

With further reference to FIG. 1, and in further preferred and non-limiting embodiments or aspects of the invention, in response to receiving a credential request (CR), the token management server 106 may validate the credential request (CR) and proceed to generate new tokens to be associated with a user's 102a, 102b corresponding transaction account. The tokens and at least part of the account data of the credential request (CR) may be stored in a token database 107 communicatively connected to the token management server 106. For each user 102a, 102b, the token management server 106 may generate a pay-send token and a pay-receive token. A pay-send token is a unique identifier, which may be encrypted, that facilitates payment from the associated user's 102a, 102b transaction account. A pay-send token is directional and is used to authorize payment from a user, not payment to a user. Similarly, a pay-receive token is a unique identifier, which may be encrypted, that facilitates payment to the associated user's 102a, 102b transaction account. A pay-receive token is directional and is used to authorize payment to a user, not payment from a user. The tokens are generated, stored in the token database 107, and communicated, e.g., in a credential transmission (CT), to the user 102a, 102b that communicated the credential request (CR). The tokens may be stored in local memory associated with the user's 102a, 102b account management device 104a, 104b.

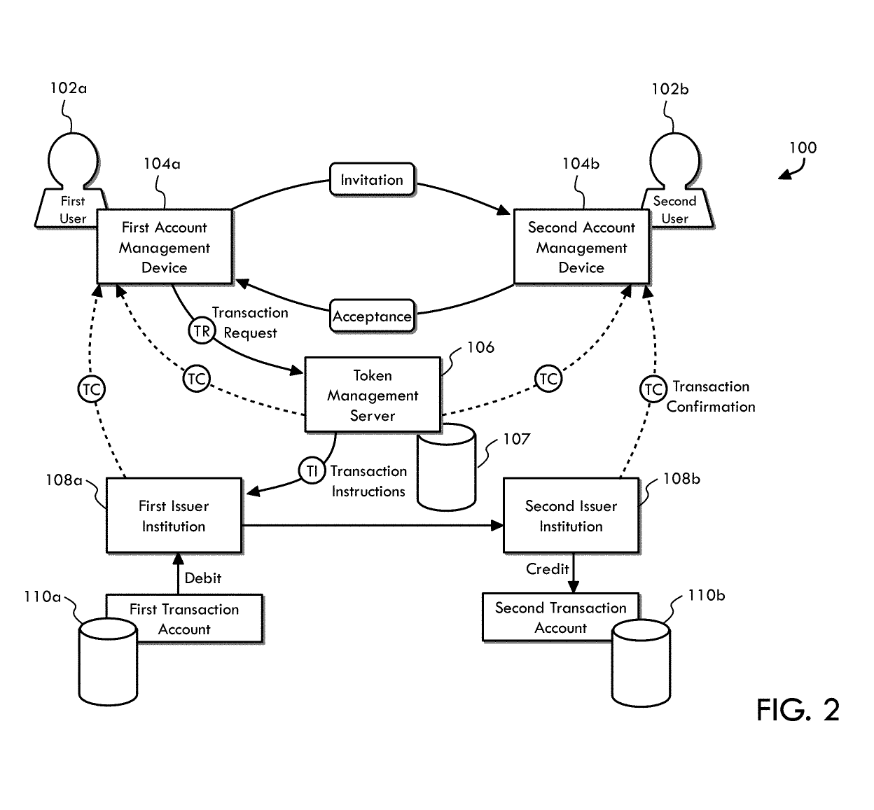

With specific reference to FIG. 2, and in preferred and non-limiting embodiments or aspects of the invention, provided is a system and method 100 for securely completing a transaction between a first transaction account of a first user 102a and a second transaction account of a second user 102b. Particularly, provided is a system and method 100 for facilitating person-to-person transaction invitation and acceptance, and facilitating completion of the transaction as requested by users 102a, 102b. A first user 102a communicates an invitation to transact to a second user 102b from the first user's 102a account management device 104a to the second user's 102b account management device 104b. The invitation to transact may include a transaction value, a first user identifier, a first user username, a transaction time, a recurrence count, a recurrence amount, a recurrence time, a recurrence termination date, a recurrence limit, or any combination thereof. The invitation to transact may include data configured to cause an invitation message to be displayed to the second user 102b on a display of the second account management device 104b and may be configured for integration with other communication methods, such as email, text message/SMS, messaging services, voicemail, application notifications, and/or the like. The invitation may be accepted, declined, or ignored by the second user 102b. The invitation to transact may be for payment from the first user 102a to the second user 102b, or for payment from the second user 102b to the first user 102a. In one preferred and non-limiting embodiment, the invitation to transact includes an email notification from the first account management device 104a to the second account management device 104b, the email notification including the first user's 102a name, a transaction value, and selectable buttons/icons for “Accept” or “Decline.” It will be appreciated that many configurations are possible.

With further reference to FIG. 2, and in further preferred and non-limiting embodiments or aspects of the invention, the second user 102b may communicate acceptance of the invitation to transact to the first user 102a. The acceptance is communicated from the second account management device 104b to the first account management device 104a. If the invitation to transact was for payment from the first user 102a to the second user 102b, the acceptance may include the second user's 102b pay-receive token. If the invitation to transact was for payment from the second user 102b to the first user 102a, the acceptance may include the second user's 102b pay-send token. It will be appreciated that, as depicted in FIG. 2, an invitation for payment from first user 102a to second user 102b may be more secure, given that a pay-receive token would be the only token transmitted from person to person, decreasing opportunities for nefarious interception or exploitation of tokens. After the first user 102a receives acceptance of the invitation to transact at the first account management device 104a, the first user 102a may proceed to instigate completion of the transaction by submitting a transaction request (TR) to the token management server 106. If paying the second user 102b, the transaction request may include the first user's 102a pay-send token, the second user's 102b pay-receive token, and the previously agreed-upon transaction value. If receiving payment from the second user 102b, the transaction request may include the first user's 102a pay-receive token, the second user's 102b pay-send token, and the previously agreed-upon transaction value.

With further reference to FIG. 2, and in further preferred and non-limiting embodiments or aspects of the invention, the token management server 106 may then, based at least partially on the received paired tokens, validate/verify the transaction (see also the description of cryptograms further below) and determine identifications of the associated first transaction account and second transaction account. Identifications can be made by directly matching tokens to account identifiers, or by matching tokens to financial devices, which correspond to transaction accounts. As depicted for the non-limiting embodiment of payment being sent to the second user 102b from the first user 102a, the token management server 106 may generate and transmit transaction instructions (TI) to the first issuer institution 108a. In such an example, the transaction instructions (TI) are configured to facilitate completion of the transaction from the first transaction account to the second transaction account, wherein the first issuer institution 108a debits the first transaction account for the transaction value and communicates with the second issuer institution 108b to credit the second transaction account for the transaction value. It will be appreciated that in the non-limiting embodiment of payment being received by the first user 102a from the second user 102b, the token management server 106 may generate and transmit transaction instructions (TI) to the second issuer institution 108b, in which the flow of communications as depicted are reversed. In such an example, the transaction instructions (TI) are configured to facilitate completion of the transaction from the second transaction account to the first transaction account, wherein the second issuer institution 108b debits the second transaction account for the transaction value and communicates with the first issuer institution 108a to credit the first transaction account for the transaction value. It will be appreciated that many configurations are possible.

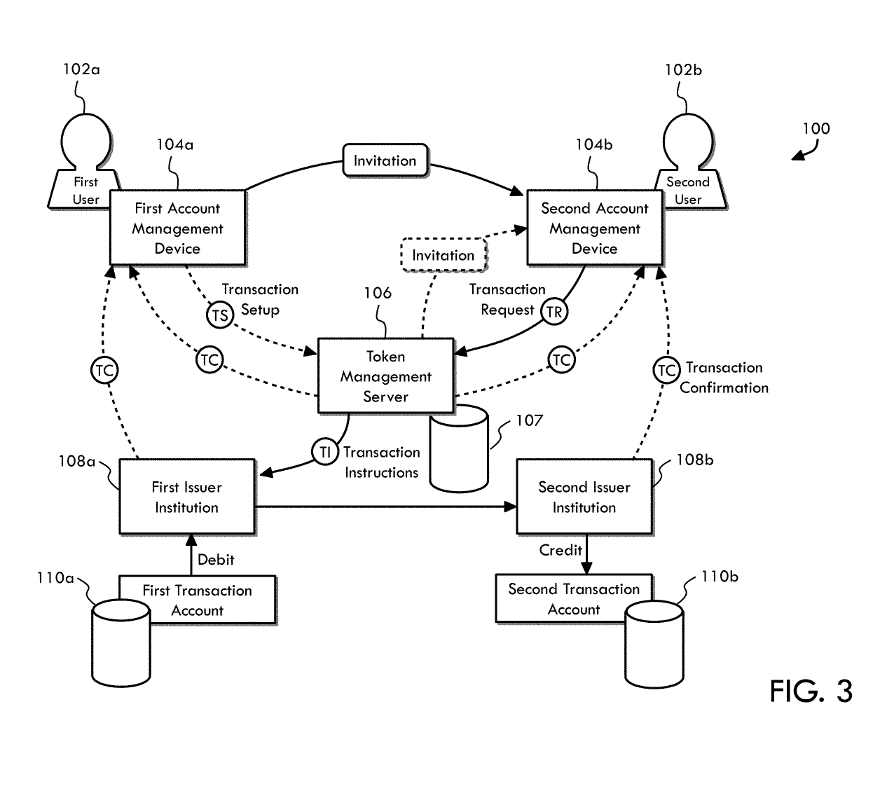

With specific reference to FIG. 3, and in preferred and non-limiting embodiments or aspects of the invention, provided is a system and method 100 for securely completing a transaction between a first transaction account of a first user 102a and a second transaction account of a second user 102b. Particularly, provided is a system and method 100 for facilitating person-to-person transaction invitation and acceptance, and facilitating completion of the transaction as requested by users 102a, 102b. A first user 102a communicates an invitation to transact to a second user 102b from the first user's 102a account management device 104a to the second user's 102b account management device 104b. The invitation to transact may include a transaction value, a first user identifier, a first user username, a recurrence count, a recurrence amount, a recurrence time, a recurrence termination date, a recurrence limit, or any combination thereof. The invitation to transact may include data configured to cause the display of an invitation message to the second user 102b on a display of the second account management device 104b and may be configured for integration with other communication methods, such as email, text message/SMS, messaging services, voicemail, application notifications, and/or the like. The invitation may be accepted, declined, or ignored by the second user 102b. The invitation to transact may be for payment from the first user 102a to the second user 102b, in which case the invitation to transact may also include the first user's 102a pay-send token. Alternatively, the invitation to transact may be for payment from the second user 102b to the first user 102a, in which case the invitation to transact may also include the first user's 102a pay-receive token. It will be appreciated that many configurations are possible. Moreover, the invitation to transact may be sent indirectly from the first user 102a to the second user 102b. For example, the first user 102a may communicate a transaction setup (TS) message to the token management server 106 to designate the second user 102b to receive or pay a transaction value. If the first user 102a intends to receive payment, the transaction setup (TS) message may also include the first user's 102a pay-receive token, or designate the first user's 102a pay-receive token as stored in the token database 107. If the first user 102a intends to send payment, the transaction setup (TS) message may also include the first user's 102a pay-send token, or designate the first user's 102a pay-send token as stored in the token database 107. The token management server 106 may then communicate an invitation to transact to the second user 102b on behalf of the first user 102a. It will be appreciated that many configurations are possible.

With further reference to FIG. 3, and in further preferred and non-limiting embodiments or aspects of the invention, the second user 102b may communicate acceptance of the invitation directly to the token management server 106 as a form of transaction request (TR). If the invitation to transact was for payment from the first user 102a to the second user 102b, the transaction request (TR) may include the second user's 102b pay-receive token. If the invitation to transact was for payment from the second user 102b to the first user 102a, the transaction request (TR) may include the second user's 102b pay-send token. Moreover, if the second user 102b was transmitted an invitation to transact by the first user 102a, then the transaction request (TR) may further include a token provided to the second user 102b by the first user 102a. It will be appreciated that, as depicted in FIG. 3, an invitation from the first user 102a requesting payment by the second user 102b may be more secure, given that a pay-receive token would be the only token transmitted from person to person, decreasing opportunities for nefarious interception or exploitation of tokens.

With further reference to FIG. 3, and in further preferred and non-limiting embodiments or aspects of the invention, after receiving the transaction request (TR) from the second user 102b, which effectively accepts the invitation to transact, the token management server 106 may then, based at least partially on the paired tokens, validate/verify the transaction (see the discussion of cryptograms further below) and determine identifications of the associated first transaction account and second transaction account. Identifications can be made by directly matching tokens to account identifiers, or by matching tokens to financial devices, which correspond to transaction accounts. As depicted for the non-limiting embodiment of payment being sent to the second user 102b from the first user 102a, the token management server 106 may generate and transmit transaction instructions (TI) to the first issuer institution 108a. In such an example, the transaction instructions (TI) are configured to facilitate completion of the transaction from the first transaction account to the second transaction account, wherein the first issuer institution 108a debits the first transaction account for the transaction value and communicates with the second issuer institution 108b to credit the second transaction account for the transaction value. It will be appreciated that in the non-limiting embodiment of payment being received by the first user 102a from the second user 102b, the token management server 106 may generate and transmit transaction instructions (TI) to the second issuer institution 108b, in which the flow of communications as depicted are reversed. In such an example, the transaction instructions (TI) are configured to facilitate completion of the transaction from the second transaction account to the first transaction account, wherein the second issuer institution 108b debits the second transaction account for the transaction value and communicates with the first issuer institution 108a to credit the first transaction account for the transaction value. It will be appreciated that many configurations are possible.

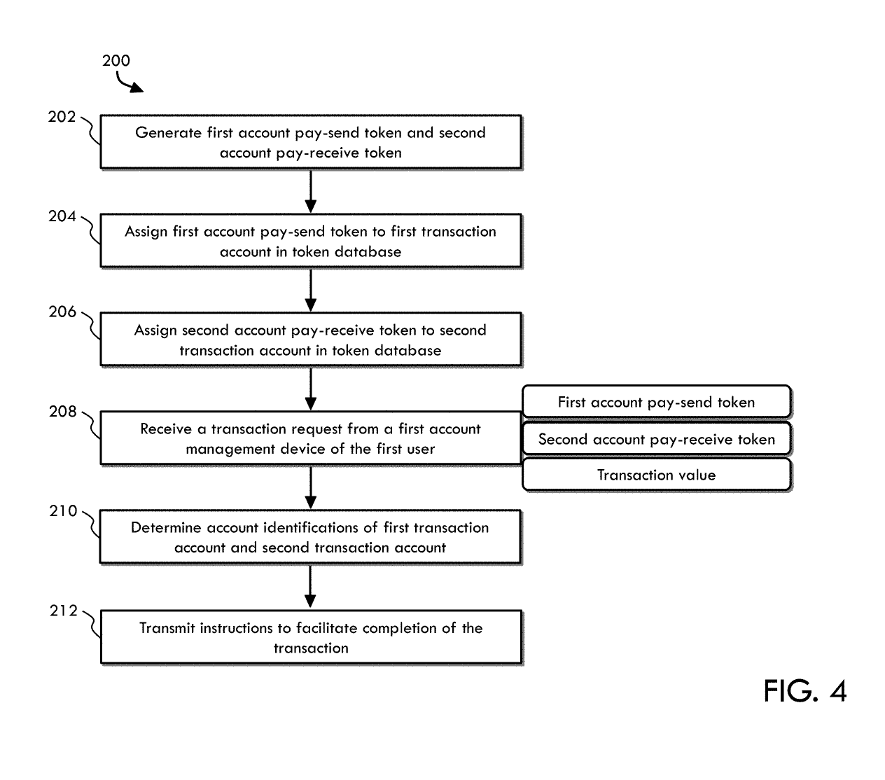

With specific reference to FIG. 4, and in preferred and non-limiting embodiments or aspects of the invention, provided is a system and method 200 for securely completing a transaction between a first transaction account of a first user and a second transaction account of a second user. Particularly, provided is a method 200 to be executed by a token management server, including at least one processor, to act in the system according to non-limiting embodiments or aspects of the present invention. At step 202, the token management server generates a first account pay-send token and a second account pay-receive token, each token corresponding to a transaction account of a user. The token management server may also generate a first account pay-receive token and a second account pay-send token. At step 204, the token management server assigns the first account pay-send token to a first transaction account of a first user in a token database. The token management server may also assign the first account pay-receive token to the first transaction account in the token database. At step 206, the token management server assigns the second account pay-receive token to a second transaction account of a second user in the token database. The token management server may also assign the second account pay-send token to the second transaction account in the token database. At step 208, the token management server receives a transaction request from a first account management device of the first user, the transaction request including the first account pay-send token, the second account pay-receive token, and a transaction value. It will be appreciated that a token management server may also receive a transaction request from a second account management device of the second user, the transaction request including the second account pay-send token, the first account pay-receive token, and a transaction value. At step 210, the token management server determines account identifications of the first transaction account and the second transaction account, based at least partially on the received paired tokens, and which may be completed by querying the token database. At step 212, the token management server transmits instructions to facilitate completion of the transaction, which may include a communication to a first issuer institution to debit the first transaction account and communicate with a second issuer institution to credit the second transaction account. The instructions may also be to the second issuer institution to initiate a transaction in the opposite direction. It will be appreciated that many configurations are possible.

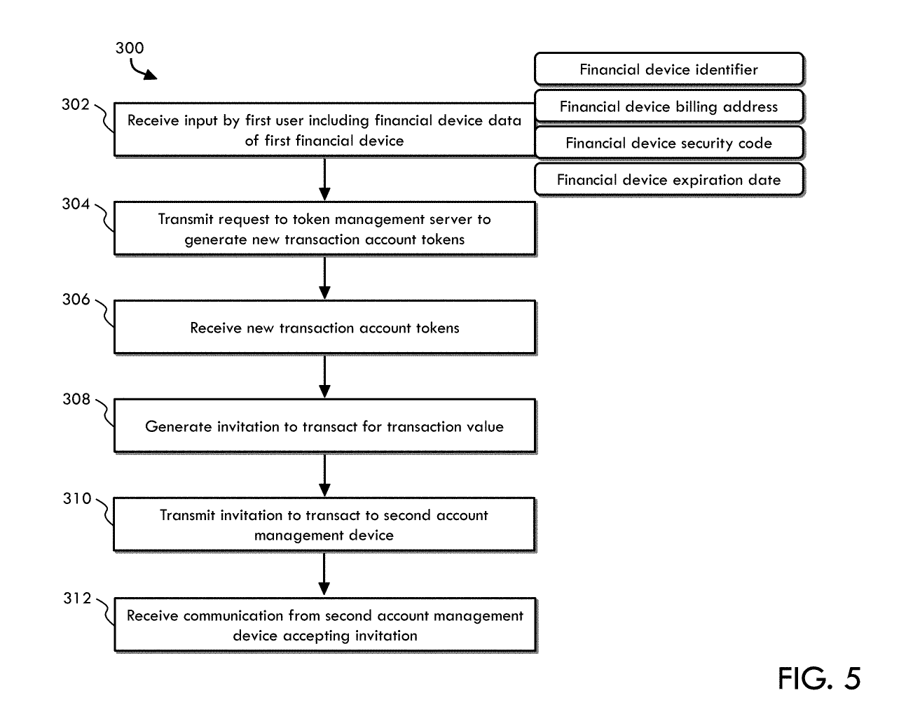

With specific reference to FIG. 5, and in preferred and non-limiting embodiments or aspects of the invention, provided is a system and method 300 for securely completing a transaction between a first transaction account of a first user and a second transaction account of a second user. Particularly, provided is a method 300 to be executed by a first account management device, including at least one processor, to act in the system according to non-limiting embodiments or aspects of the present invention. It will be appreciated that method 300 may be conducted for a second account management device, or any number of additional account management devices. At step 302, the first account management device receives input by a first user, the input including financial device data for a first financial device of the first user. The financial device data may include a financial device identifier, a financial device billing address, a financial device security code, a financial device expiration date, and/or the like. At step 304, the first account management device transmits a request to the token management server to generate new transaction account tokens for a first transaction account of the first user. The transaction account tokens may include a first account pay-send token and a first account pay-receive token. At step 306, the first account management device receives the new transaction account tokens from the token management server and may store the tokens in local memory. At step 308, the first account management device generates an invitation to transact for a transaction value, and at step 310 the first account management device transmits the invitation, including the first account pay-send token or the first account pay-receive token, to a second account management device of a second user. At step 312, if the second user agrees to the transaction, the first account management device receives a communication from the second account management device, the communication accepting the invitation and including a second account pay-send token or a second account pay-receive token, whichever is required to complete the pay-send and pay-receive token pair. It will be appreciated that many configurations are possible.

With further reference to the foregoing figures, and in further preferred and non-limiting embodiments or aspects of the invention, the token management server 106 may generate verification cryptograms for authentication of the generated transaction account tokens. A pay-send verification cryptogram may be generated for each pay-send token, to authenticate the corresponding pay-send token and define a domain of permitted payments using the corresponding pay-send token. The domain of permitted payments may be defined by one or more parameters, including a maximum volume, a permitted time range, a permitted recipient, a permitted recipient type, and/or the like. The pay-send verification cryptogram may be sent along with the pay-send token in communications from the associated user to other users or to the token management server. The token management server may also generate a pay-receive verification cryptogram for each pay-receive token. The pay-receive verification cryptogram may be used to authenticate corresponding pay-receive tokens and define a domain of permitted payments to the corresponding pay-receive token. The domain of permitted payments may be defined by one or more parameters, including a maximum volume, a permitted time range, a permitted payer, a permitted payer type, and/or the like. The pay-receive verification cryptogram may be sent along with the pay-receive token in communications from the associated user to other users or to the token management server. It will be appreciated that many configurations are possible.

With further reference to the foregoing figures, and in further preferred and non-limiting embodiments or aspects of the invention, after the requested transaction is completed in response to the instructions from the token management server 106, a transaction confirmation (TC) message may be sent back to the first account management device 104a and/or the second account management device 104b. In one preferred and non-liming example, the token management server 106 transmits a transaction confirmation (TC) message to each account management device 104a, 104b. In another preferred and non-limiting example, the first issuer institution 108a transmits a transaction confirmation (TC) message to the first account management device 104a, and the second issuer institution 108b transmits a transaction confirmation (TC) message to the second account management device 104b. It will be appreciated that the transaction confirmation (TC) may be sent to a user device that is separate from the account management device 104a, 104b. The transaction confirmation (TC) message may include data configured to display a message to a respective user 102a, 102b to indicate that the transaction was completed. It will be appreciated that many configurations are possible.

With further reference to the foregoing figures, and in further preferred and non-limiting embodiments or aspects of the invention, it will be appreciated that the invitation to transact may be an invitation for recurring transactions. In such a case, the first user 102a may send the second user 102b an invitation to transact for multiple transactions, and the invitation may include a recurrence count, a recurrence amount, a recurrence time, a recurrence termination date, a recurrence limit, and/or the like. If the invitation to transact is for multiple payments to the second user 102b, the first account management device 104a may retain the second account pay-receive token and repeatedly transmit transaction requests to the token management server 106 at the agreed-upon intervals/predetermined times. The first account management device 104a may repeatedly transmit transaction requests without further communicating invitations to transact and without receiving further acceptances. If the invitation to transact is for multiple payments from the second user 102b, the second account management device 104b may retain the first account pay-receive token and repeatedly transmit transaction requests to the token management server 106 at the agreed-upon intervals/predetermined times. The second account management device 104b may repeatedly transmit transaction requests without further receiving invitations to transact and without transmitting further acceptances. It will be appreciated that many configurations are possible.

With further reference to the foregoing figures, it will be appreciated that an invitation to transact may be for payment from one paying user to multiple recipient users. The invitation to transact may be sent to the multiple recipient users, who may be provided with the ability to individually or collectively accept the invitation to transact. Furthermore, the recipient users may be provided with the controls to apportion reception of the invitation's transaction value among the recipient users. Acceptance of the invitation to transact may include each recipient user communicating their pay-receive token to the one paying user, or alternatively, each recipient user communicating their pay-receive token to the token management server 106 to be matched up with the payer's pay-send token. Similarly, the invitation to transact may be for payment from multiple paying users to a single recipient user. Account management devices for each paying user may collectively or independently send an invitation to transact to the one recipient user. Acceptance of the invitation to transact may include the one recipient user's pay-receive token being sent to each paying user, or alternatively, the one recipient user communicating its pay-receive token to the token management server 106 to be matched up with each paying user's pay-send token. Similar processes may be used for many-to-many payer or recipient schemes, and verification cryptograms may be used for and communicated along with one or more involved tokens. It will be appreciated that many configurations are possible.

With further reference to the foregoing figures, it will be appreciated that an invitation to transact may be for payment from multiple paying users to one recipient user. The invitation to transact may be sent to the multiple paying users, with or without the recipient's pay-send token, and the multiple paying users may be provided with the ability to individually or collectively accept the invitation to transact. Furthermore, the paying users may be provided with the controls to apportion payment of the invitation's transaction value among the paying users. Acceptance of the invitation to transact may include each paying user communicating their pay-send token to the one recipient user, or alternatively, each paying user communicating their pay-send token to the token management server 106 to be matched up with the recipient's pay-receive token. Similarly, the invitation to transact may be for payment from one paying user to multiple recipient users. Account management devices for each recipient user may collectively or independently send an invitation to transact to the one paying user, and invitation(s) to transact may or may not include each recipient's pay-receive token. Acceptance of the invitation to transact may include the one paying user's pay-send token being sent to each recipient user, or alternatively, the one paying user communicating its pay-send token to the token management server 106 to be matched up with each recipient user's pay-receive token. Similar processes may be used for many-to-many payer or recipient schemes, and verification cryptograms may be used for and communicated along with one or more involved tokens. It will be appreciated that many configurations are possible.

With further reference to the foregoing figures, consider the following non-limiting example application of the present invention. Two entities, “A” and “B,” wish to complete a transaction between their two transaction accounts. Entity A manages their transaction account by using a smartphone running an electronic wallet (an account management device). When entity A registers their credit card (financial device) with the electronic wallet, entity A enters financial device data that is sent to a token management server, which is associated with a transaction service provider. The token management server generates a pay-send token and a pay-receive token that are assigned to entity A's transaction account (directly or by association with the credit card) and the tokens are transmitted to entity A's smartphone, which stores the tokens encrypted in local memory. The token management server stores the token-account association in a token database along with a preferred communication method for entity A. Entity B manages their transaction account by using a desktop computer (account management device) that accesses an account management portal on a website provided by their bank (issuer institution). When entity B requests an enrollment process, their computer or a banking server communicates with the token management server, which generates a pay-send token and a pay-receive token to associate with entity B's transaction account. The tokens are stored on the banking server that entity B accesses via the web portal, and the token-account association is stored in the token database accessible along with a preferred communication method for entity B. Cryptograms may be generated by the token management server and stored with each entity's tokens, either at token creation or when an invitation to transact is generated or received.

With further reference to the preceding example, entity A may desire to pay entity B money, such as for services that entity B provided entity A. Entity A then opens an application or other communication system via their smartphone and generates a message to entity B to invite entity B to receive a payment from Entity A. The invitation includes the transaction value and a message, such as “Entity A would like to pay you $20 for services rendered. Do you accept?” This message is received by entity B, through their computer, and is displayed for acceptance or denial. Entity B wants to receive the money, and agrees to the amount, and selects a control or button to accept the transaction. An acceptance message is communicated back to entity B's smartphone, and the acceptance message contains entity B's pay-receive token and a cryptogram that defines token scope, such as limiting the pay-receive token's use to payment from entity A, within the next week, and for payments less than $100. Entity A may receive a message that reads “Entity B accepts your offer to pay $20 for services rendered. Submit payment now?” Entity A then selects a control or button on their smartphone to submit a transaction request to the token management server. The transaction request includes at least entity B's pay-receive token and cryptogram, entity A's pay-send token and cryptogram, and the transaction value. The token management server receives the transaction request, sends a receipt message to entity A's smartphone, retrieves the account information for each entity by referencing the received tokens, and generates transaction instructions to entity A's credit card issuer. The transaction instructions are configured to cause entity A's issuer to debit entity A's account by $20 and communicate with entity B's bank to credit entity B's account by $20. The token management server, in communication with entity A's issuer, receives confirmation that the transaction has been completed, and thereafter generates and transmits a message to entity A's smartphone and entity B's computer that the transaction has been completed. It will be appreciated that the preceding is a non-limiting example and that the present invention may have many configurations of amounts, invitations, devices, and users.

Although the invention has been described in detail for the purpose of illustration based on what is currently considered to be the most practical and preferred and non-limiting embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A computer-implemented method for securely completing a transaction between a first transaction account of a first user and a second transaction account of a second user, the method comprising:
generating, with at least one processor, a first account pay-send token and a second account pay-receive token;
assigning, with at least one processor, the first account pay-send token to the first transaction account in a token database, the first transaction account associated with at least one first financial device;
assigning, with at least one processor, the second account pay-receive token to the second transaction account in the token database, the second transaction account associated with at least one second financial device;
receiving, with at least one processor, a transaction request from a first account management device of the first user, the transaction request comprising at least the first account pay-send token, the second account pay-receive token, and a transaction value;
determining, with at least one processor and based at least partially on the first account pay-send token and the second account pay-receive token, account identifications for the first transaction account and the second transaction account; and
transmitting, with at least one processor and in response to determining the account identifications, transaction instructions to at least an issuer institution of the at least one first financial device, the transaction instructions configured to facilitate completion of the transaction from the first transaction account to the second transaction account for the transaction value.

2. The method of claim 1, further comprising communicating, with at least one processor, a confirmation to the first account management device of the first user and a confirmation to a second account management device of the second user when the transaction is completed.

3. The method of claim 2, further comprising communicating, from the first account management device to the second account management device and with at least one processor, an offer to pay the transaction value.

4. The method of claim 3, further comprising communicating, from the second account management device to the first account management device and with at least one processor, an acceptance of the offer, the acceptance comprising the second account pay-receive token.

5. The method of claim 4, wherein the first account management device retains the second account pay-receive token and transmits transaction requests at predetermined intervals without further communicating offers to pay transaction values and without further receiving acceptances of offers to pay transaction values.

6. The method of claim 4, further comprising generating, with at least one processor, a pay-receive verification cryptogram to authenticate the second account pay-receive token, the pay-receive verification cryptogram configured to be transmitted with the second account pay-receive token from the second account management device to the first account management device in the acceptance of the offer by the second user.

7. The method of claim 6, further comprising generating, with at least one processor, a pay-send verification cryptogram to authenticate the first account pay-send token and define a domain of permitted payments using the first account pay-send token, the pay-send verification cryptogram configured to be transmitted with the first account pay-send token, the second account pay-receive token, and the pay-receive verification cryptogram from the first account management device in the transaction request.

8. The method of claim 1, further comprising:
generating, with at least one processor, a first account pay-receive token and a second account pay-send token;
assigning, with at least one processor, the first account pay-receive token to the first transaction account in the token database and the second account pay-send token to the second transaction account in the token database;
transmitting, with at least one processor, the first account pay-send token and the first account pay-receive token to the first account management device of the first user in response to registration of the at least one first financial device with a digital wallet; and
transmitting, with at least one processor, the second account pay-send token and the second account pay-receive token to a second account management device of the second user in response to registration of the at least one second financial device with a digital wallet.

9. The method of claim 1, wherein the transaction comprises a recurring transaction, the method further comprising communicating, with at least one processor and based at least partially on the transaction request, with at least the issuer institution of the at least one first financial device to complete the recurring transaction at predetermined intervals.

10. A system for securely completing a transaction between a first transaction account of a first user and a second transaction account of a second user, the system comprising:
a first non-transitory computer readable medium containing program instructions executable by a first account management device comprising at least one processor, the program instructions programmed or configured to facilitate management of at least one first financial device associated with the first transaction account, the first transaction account being assigned at least a first account pay-send token;
a second non-transitory computer readable medium containing program instructions executable by a second account management device comprising at least one processor, the program instructions programmed or configured to facilitate management of at least one second financial device associated with the second transaction account, the second transaction account being assigned at least a second account pay-receive token; and
at least one token management server in communication with a token database and programmed or configured to:
generate the first account pay-send token and the second account pay-receive token;
assign the first account pay-send token to the first transaction account in the token database;
assign the second account pay-receive token to the second transaction account in the token database; and
in response to receiving a transaction request from the first account management device, query financial devices corresponding to each token and communicate with at least an issuer institution of the at least one first financial device to complete the transaction from the first transaction account to the second transaction account for a transaction value.

11. The system of claim 10, wherein the transaction request comprises at least the first account pay-send token, the second account pay-receive token, and the transaction value.

12. The system of claim 10, wherein the at least one token management server is further programmed or configured to communicate a confirmation to the first user device and the second user device when the transaction is completed.

13. The system of claim 10, wherein the at least one token management server is further programmed or configured to generate a pay-receive verification cryptogram to authenticate the second account pay-receive token, the pay-receive verification cryptogram configured to be transmitted with the second account pay-receive token from the second account management device to the first account management device for acceptance of the transaction by the second user.

14. The system of claim 13, wherein the at least one token management server is further programmed or configured to generate a pay-send verification cryptogram to authenticate the first account pay-send token and define a domain of permitted payments using the first account pay-send token, the pay-send verification cryptogram configured to be transmitted with the first account pay-send token, the second account pay-receive token, and the pay-receive verification cryptogram from the first account management device in the transaction request.

15. The system of claim 10, wherein the at least one token management server is further programmed or configured to:
generate a first account pay-receive token and a second account pay-send token;
assign the first account pay-receive token to the first transaction account in the token database and the second account pay-send token to the second transaction account in the token database;
transmit the first account pay-send token and the first account pay-receive token to the first account management device in response to registration of the at least one first financial device with a digital wallet; and
transmit the second account pay-send token and the second account pay-receive token to the second account management device in response to registration of the at least one second financial device with a digital wallet.

16. The system of claim 10, wherein the transaction comprises a recurring transaction and the transaction request is further configured to cause the at least one token management server to communicate with at least the issuer institution of the at least one first financial device to complete the recurring transaction at predetermined intervals.

17. A computer-implemented method for securely completing a transaction between a first transaction account of a first user and a second transaction account of a second user, the method comprising:
receiving, with at least one processor, input by the first user comprising financial device data for a first financial device associated with the first transaction account, the financial device data comprising at least one of the following: a first financial device identifier, a first financial device billing address, a first financial device security code, a first financial device expiration date, or any combination thereof;
transmitting, with at least one processor, a request to a token management server to generate new transaction account tokens, the new transaction account tokens comprising a first account pay-send token and a first account pay-receive token associated with the first transaction account;
receiving from the token management server, with at least one processor, the new transaction account tokens;
generating and transmitting to an account management device of the second user, with at least one processor, an invitation to transact for a transaction value; and
receiving from the account management device of the second user, with at least one processor, a communication accepting the invitation to transact.

18. The method of claim 17, wherein the invitation to transact is for payment from the first user to the second user, and wherein the communication accepting the invitation comprises a second account pay-receive token associated with the second transaction account, the method further comprising transmitting, with at least one processor, a transaction request to the token management server comprising the first account pay-send token, the second account pay-receive token, and the transaction value, the transaction request configured to cause the token management server to query financial devices corresponding to each transmitted token and communicate with at least an issuer institution of the first financial device to complete the transaction from the first transaction account to the second transaction account for the transaction value.

19. The method of claim 18, wherein the transaction comprises a recurring transaction and the transaction request is further configured to cause the token management server to communicate with at least the issuer institution of the first financial device to complete the recurring transaction at predetermined intervals.

20. The method of claim 18, wherein the transaction comprises a repeated transaction, the method further comprising storing the second account pay-receive token for transmission in the transaction request, the transaction request to be initiated by the first user at a plurality of different times.

21. The method of claim 18, wherein the communication accepting the invitation to transact further comprises a pay-receive verification cryptogram to authenticate the second account pay-receive token.

22. The system of claim 21, wherein the transaction request further comprises a pay-send verification cryptogram to authenticate the first account pay-send token and define a domain of permitted payments using the first account pay-send token.

23. The method of claim 17, wherein the invitation to transact is for payment from the second user to the first user and comprises the first account pay-receive token, and wherein the communication accepting the invitation represents confirmation of a submission of a transaction request to the token management server by the account management device of the second user, the first account pay-receive token configured to be paired with a second account pay-send token associated with the second transaction account and to be transmitted in the transaction request to the token management server.
